(19) United States
(12) Patent Application Publication
(10) Pub. No.: US 2013/0104182 A1
(43) Pub. Date: Apr. 25, 2013

(54) Method and Apparatus for Fast Data Delivery on a Digital Pixel Cable

(71) Applicants: Jingxi Zhang, Foster City, CA (US); Michael Meng, San Jose, CA (US)

(72) Inventors: Jingxi Zhang, Foster City, CA (US); Michael Meng, San Jose, CA (US)

(73) Assignee: Jupiter Systems, Hayward, CA (US)

(21) Appl. No.: 13/445,664

(22) Filed: Apr. 12, 2012

Related U.S. Application Data
(60) Provisional application No. 61/474,682, filed on Apr. 12, 2011.

(51) Int. Cl. H04N 7/10

(52) U.S. Cl. CPC H04N 7/102
USPC 725/127

(57) ABSTRACT

The present invention relates to delivery of non-image data frames via a high-speed digital pixel cable using a main pixel channel of the cable to carry non-image data frames and using a side channel of the cable to indicate that particular data frames sent on the main pixel channel are to be treated as non-image data instead of pixel data. The non-image data may, for instance be edge blending, warping or color balance data. Alternatively, it could be a firmware update. The high-speed digital pixel cable could be a DVI, HDMI or DisplayPort-compatible cable. The side channel could be a DDC, CEC or custom channel. Further aspects of the technology disclosed are described in the accompanying specification, claims and figures.

### RELATED CASE

This application claims the benefit of U.S. Provisional App. No. 61/474,682, by the same title and listing the same inventors as this application, filed on Apr. 12, 2011. This related application is hereby incorporated by reference.

### BACKGROUND OF THE INVENTION

The present invention relates to delivery of non-image data frames via a high-speed digital pixel cable using a main pixel channel of the cable to carry non-image data frames and using a side channel of the cable to indicate that particular data frames sent on the main pixel channel are to be treated as non-image data instead of pixel data. The non-image data may, for instance be edge blending, warping or color balance data. Alternatively, it could be a firmware update. The high-speed digital pixel cable could be a DVI, HDMI or DisplayPort-compatible cable. The side channel could be a DDC, CEC or custom channel.

Three standards for high-speed digital pixel cables are DVI, HDMI and DisplayPort. The standards typically are implemented using cables with multiple metal conductors. Sometimes, a transducer converts signals for transmission via an optical medium, instead of copper cable. Each of the standards has a standard-compliant port and coupler. See, FIGS. 1-3.

A high-speed digital pixel cable is sometimes used to transmit data to a pixel processing appliance and from the appliance onto a further device, such as a projector or a flat-panel display. The standards for high-speed digital pixel cables afford high-bandwidth to support combinations of high resolution and fast display refresh rates. Pixel data, which is used to create images, is transmitted on a main pixel channel.

The DVI, HDMI and DisplayPort standards all support a side channel known as the Display Data Channel (DDC.) The standard for DDC is promulgated by the Video Electronics Standards Association (VESA). Operation of DDC typically is compliant with the I2C bus specification. The VESA DDC/CI standard document, version 1.1 was released on Oct. 29, 2004. It specifies the clock for DDC in standard mode as having a clock rate equivalent to 100 kHz. The I2C specification, referenced for DDC implementation, also calls out fast and high-speed modes of operation. The bus specification for I2C is intended to minimize potential bus contention (VESA Standard 1.1, at 17), so the basic command set limits the data length of commands to fragments of 32 bytes. Each of the commands specified in section 4 of the specification document includes a recommended interval for the host to wait after sending a 32 byte message. The recommended wait intervals range from 40 ms to 200 ms, depending on the commanded operation. This wait time dominates the throughput of the DDC side channel.

An alternative side channel arrangement is optional for DisplayPort and is included in the new Apple/Intel Thunderbolt specification. For DisplayPort, the config2 conductor is available, optionally, to carry an Ethernet channel. Similarly, Thunderbolt anticipates bundling an Ethernet channel into the high-speed digital pixel cable. Neither of these implementations for bundling Ethernet into a high-speed digital pixel cable have gained popularity at the writing of this disclosure.

New designs of high-speed digital pixel transmission that create previously unrecognized possibilities can be very useful.

### SUMMARY OF THE INVENTION

The present invention relates to delivery of non-image data frames via a high-speed digital pixel cable using a main pixel channel of the cable to carry non-image data frames and using a side channel of the cable to indicate that particular data frames sent on the main pixel channel are to be treated as non-image data instead of pixel data. The non-image data may, for instance be edge blending, warping or color balance data. Alternatively, it could be a firmware update. The high-speed digital pixel cable could be a DVI, HDMI or DisplayPort-compatible cable. The side channel could be a DDC, CEC or custom channel. Further aspects of the technology disclosed are described in the accompanying specification, claims and figures.

### BRIEF DESCRIPTION OF THE DRAWINGS

FIG. 1 includes a photograph and pin out diagram of a DVI-compliant connector.

FIG. 2 includes a photograph and pin out diagram of an HDMI-compliant connector.

FIG. 3 includes an illustration and pin out diagram of a DisplayPort connector.

FIG. 4 is a high-level block diagram taken from the Digital Visual Interface (DVI) standard revision 1.0, published by the Digital Display Working Group (Apr. 2, 1999).

FIG. 5 illustrates a high-level block diagram of one implementation of the technology disclosed.

FIG. 6 depicts application of the technology disclosed to edge blending.

FIG. 7 depicts a warping application of the technology disclosed.

FIG. 8 depicts color/brightness mapping of the display.

FIG. 9 depicts of an astronomical bell tower in Prague painted with light to celebrate the tower's 600th anniversary.

### DETAILED DESCRIPTION

The assignee of this application, Jupiter Systems, is in a niche market that has special requirements. The assignee makes controllers for display walls. We've all seen display walls in movies or newsreels that portray Houston Mission Control, a bunker deep in the Rocky Mountains, or a Metropolitan subway control center. A seamless display wall includes a display screen and multiple projectors that backlight a display screen. Alternatively, the display wall may include multiple flat-panel displays. There is a niche market for controllers that allow dynamic configuration of the images displayed on parts of the display wall and across multiple parts. As the technologies evolved, two primary configurations that output video signals to drive parts of the display walls have emerged: 1) a server or processor with multiple display blades for multiple video outputs and 2) individual video output nodes connected to a server or processor that generates one or more video outputs as directed by the server or processor.

A video output from a blade or a video output node may be further processed by a pixel processing node, which is the focus of this disclosure. The pixel processing node receives a signal via a high-speed digital pixel cable. Current pixel processing node capabilities include edge blending, image warping, and color/brightness compensation. More generally, a pixel processing node could apply any of the operations supported by a pixel processor. A variety of these operations are described in U.S. Pat. No. 7,384,158, which is hereby incorporated by reference. Other capabilities are described in the presentation entitled “Solving Multiple Customer Pain Points: LED backlit LCD Panels and Smartphone Cameras”, presented by Paul Russo, Chairman and CEO of GEO Semiconductor Inc. at AGC Financial Conference (Oct. 27, 2001). Mr. Russo's presentation is also incorporated by reference.

In the course of servicing this niche market, the inventors realized an opportunity for high-speed delivery of non-image data to pixel processing nodes and other smart devices that may require a large amount of data, over otherwise standard compliant high-speed digital pixel cables. The conventional way of servicing data requirements of smart devices has been to use a USB or Ethernet cable, in addition to the high-speed pixel cable. Non-image data goes over the USB or Ethernet channel and image data goes over the main pixel channel of the cable. This increases complexity and cost.

These inventors had control over both the transmitter to and receiver of signals in the pixel processing nodes, so they had the unusual freedom to modify transmission and receipt of data over the high-speed pixel cables. They had the freedom to modify implementation of the DVI, HDMI or DisplayPort standard, because they controlled the firmware that transmitted and received signals over the high-speed digital pixel cables. With this unusual design freedom, they conceived of the technology described below that uses some data frames transmitted over the digital pixel cables to carry non-image data, instead of the standard-specified image data. Using a side channel, the transmitter signals the receiver when data frames contain non-image data.

This mode of transmitting non-image data has proven useful for edge blending when a single image is created from multiple projectors. It will be useful for warp mapping and for color and/or brightness correction. It also is useful for sending arbitrary data to the pixel processing nodes, such as firmware or software updates. With this introduction mind, we turn to the figures.

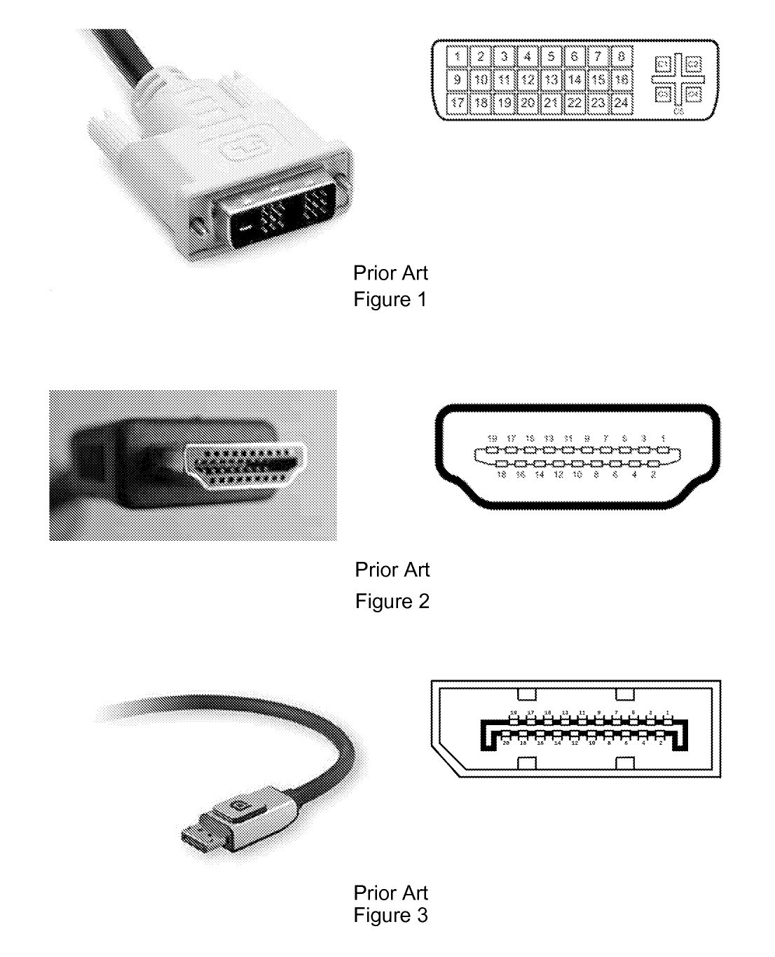

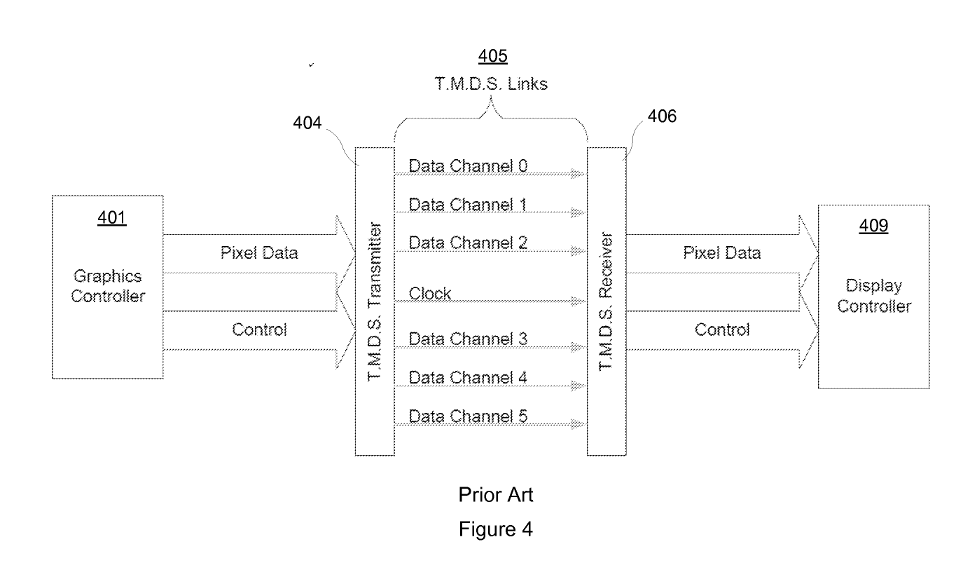

As indicated in the Background section, FIGS. 1-4 are prior art. FIG. 1 includes a photograph and pin out diagram of a DVI-compliant connector. FIG. 2 includes a photograph and pin out diagram of an HDMI-compliant connector. FIG. 3 includes an illustration and pin out diagram of a DisplayPort connector. FIG. 4 is taken from the Digital Visual Interface (DVI) standard revision 1.0, published by the Digital Display Working Group (Apr. 2, 1999). The DVI revision 1 standard document, figure 2-1 on page 10 gives an overview of the transition minimized differential signaling (TMDS) protocol. In this figure, a graphics controller 401 uses a TMDS transmitter 404 to send pixel or image data to a display controller 409 via a TMDS receiver 406. The TMDS sub channels 405 of the high-speed digital pixel cable are depicted as data and clock channels. The TMDS sub channels are, by standard, dedicated to image data and not used for non-image data.

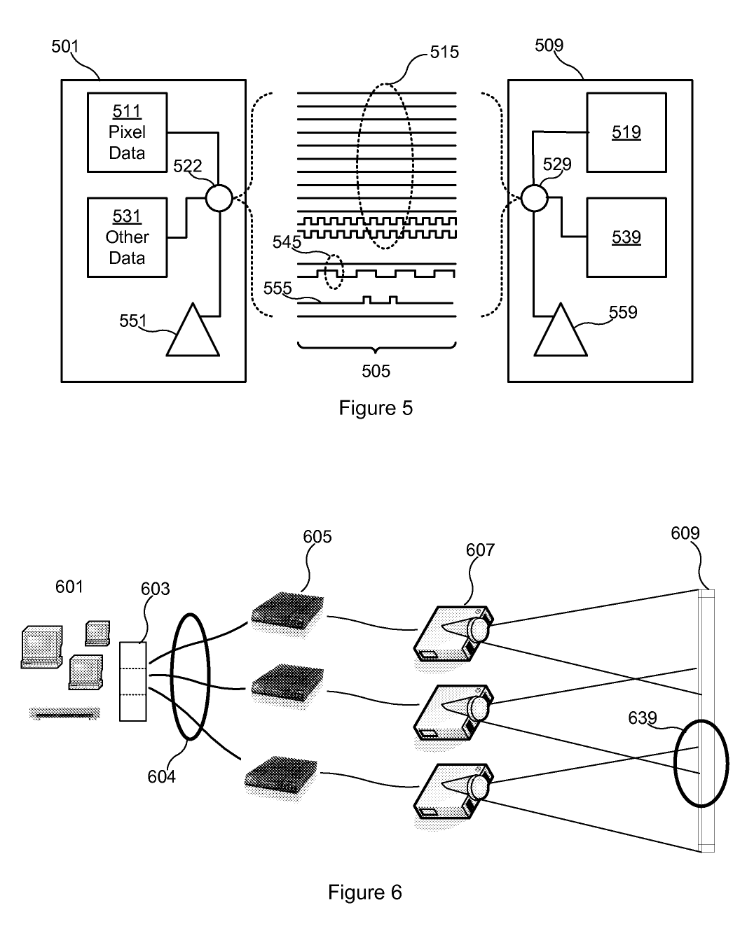

FIG. 5 is a high-level block diagram of one implementation of the technology disclosed. The transmitter 501 and receiver 509 are indicated. In the transmitter, buffers containing pixel or image data 511 and other or non-image data 531 are depicted. Physically, these could be the same buffer with dual ported memory for receiving data and immediately transmitting it. They could be fast memory capable of being loaded and then queried, while maintaining the desired transmission rate. They could be segments of the single buffer memory or implemented as multiple memory banks If separate memories are used, a selector 522 controls whether pixel or other data is transmitted via the high-speed digital pixel cable 505. If separate image data and non-image data memories were used, a selector 522 would determine, at least logically, whether pixel or other data was being loaded into the buffer. The controller 551 at least signals whether pixel or other data is being transmitted in the particular data frame. If separate buffers 511, 531 are used to buffer image and non-image data, the controller 551 also will signal the selector 522.

Sub channels of the high-speed digital pixel cable 505 are indicated as connecting the transmitter 501 and receiver 509. Sub channels of a main pixel channel 515, such as TMDS sub channels of the DVI standard, are carried by the high-speed digital pixel cable. Contributing to the DVI standard, TMDS includes multiple data channels and a pair of clock channels. We refer collectively to these multiple sub channels and clock channels as the main pixel channel. This main pixel channel supports very high data throughput. It carries out the main function the cable, which is to carry pixel data from the transmitter to the receiver. FIG. 5 also depicts the DDC channel 545, including data and timing. The figure suggests that the DDC channel clock runs much slower than the main pixel channel clock. The DDC channel can be used by the controller 551 to signal which data frames are pixel or other data so a corresponding component 591 of the receiver 509 can properly handle the received data. As an alternative implementation of signaling by the controller 551, a spare sub channel 555 of the high-speed digital pixel cable could be used to signal when non-image data is being transmitted in a data frame, instead of pixel image data. With a dedicated sub channel, the signal could be as simple as a high or low signal when non-image data is being transmitted and the opposite when pixel image data is being transmitted. Alternatively, the signal could be a command, which would support shared use of the sub channel.

When the pixel processing node is a standalone device, it typically has input and output ports for high-speed digital pixel cables. An integrated pixel processing node may only have input port(s) for at least one high-speed digital pixel cable. As used in this disclosure, the pixel processing node can be a separate box or can be incorporated into another device, such as a projector, a flat panel display or smart display.

The technology disclosed also can be applied to board and chip components or a logic block of a chip, such as system on a chip. A board, component or chip level “pixel processing component,” as opposed to a so-called pixel processing node, may have input pins for traces on a circuit or component board that implement a main pixel channel and a side channel, rather than using a high-speed digital pixel cable. Or, the main pixel and side channels may be conductors between logic blocks.

The block diagram indicates that the receiver 509 includes components analogous to the transmitter components. Buffers for pixel and other data 519, 539 may be physically separate buffers or shared, logically or physically selected by a selector 529 responsive to a selection signal received 559. The details of the buffering are not important to this disclosure; while the buffers could be separate, they also could be part of the same physical memory structure, either timesharing a block of memory or using separate memory segments.

When the high-speed digital pixel cable is DVI, HDMI or DisplayPort compliant, one option for a frame-type signaling side channel is the use of the low-speed Display Data Channel for an extended command that implements frame-type signaling. The DDC channel is typically implemented in DVI using pins 6-7. It is specified as being compliant with I2C. In HDMI, DDC may be implemented using pins 15-16. In DisplayPort, DDC is carried on the AUX channel, typically using pins 15 and 17.

When the high-speed digital cable is HDMI or DisplayPort compliant, another option for the side channel would be to extend the Consumer Electronics Control (CEC) command set. On an HDMI cable, CEC commands typically are carried on pin 13. On a DisplayPort cable, they are typically carried on the AUX channel on config2 pin 14.

Alternatively, each of the DVI, HDMI and DisplayPort standards have one or more sub channels that could be dedicated to signaling the frame type. In DVI, unassigned pin 8 could be used for a simple side channel. This dedicated sub channel could signal whether a frame buffer contains image or non-image data. Alternatively, when the DVI cable is used for digital signaling, any of the unused analog pins could be used to implement a side channel. With this side channel, a wide variety of signals could be used, including commands, voltages and currents. The signal could be one bit or multi-bit. If the side channel were shared with other uses, a shared signaling protocol would be required.

When the high-speed digital cable is HDMI, the reserved pin 14 could be used for a dedicated channel, employing commands, voltages or currents for frame type signaling.

When the high-speed digital cable is DisplayPort, the config2 sub channel, which is optionally available for Ethernet, could be dedicated to or shared for use signaling frame types. Even a timed Ethernet signal could be used to signal frame type, if config2 carried Ethernet. However, collisions would need to be avoided or provision made for retransmitting non-image data frames in case of an Ethernet collision.

This technology may be extended by or combined with a discovery protocol to permit an extended transmitter or receiver to sense whether or not a paired receiver or transmitter was capable of sending both image and non-image data over a high-speed digital pixel cable and indicating which data frames are image and non-image data.

More generally, the technology disclosed will work with any physical media that uses TMDS signaling for a main pixel channel and has available a side channel for indicating which data frames convey image and which convey non-image data.

FIG. 6 depicts application of the technology disclosed to edge blending. The elements depicted include one or more sources 601, multiple projectors 607 and a display screen 609 onto which overlapping images 639 are projected. An image controller 603 generates image data to be used by the projectors 607. The image controller may, for instance, be a server with multiple blades, such as Jupiter Systems Fusion Catalyst™ that has multiple video output ports to which high-speed digital pixel cables 604 are attached. [*** Please get the product identification right for me, as I did not stop to go through the product line, knowing that you could easily set this right. *** ] Image controller 603 may combined with be a plurality of video output nodes, such as Jupiter Systems PixelNet™ Teammate output nodes, which each include at least one video output port to which a high-speed digital pixel cable 604 is attached. The image controller 603 directly or indirectly uses a high-speed digital pixel cable 604 to send image and non-image data to each of the pixel processing units 605. Pixel processing units applied to edge blending may be warp/blend nodes available commercially from assignee Jupiter Systems (or, at least, released by Jupiter after the filing of this application.) The pixel processing nodes include a receiver 509 as in FIG. 5.

Image controller 603 sends both image data and non-image data over the high-speed digital pixel cables 604 to the pixel processing nodes 605. A blend map specifies on a pixel-by-pixel basis brightness coefficients that indicate how brightly each of the pixels in the image data frames should be displayed. When blend or other coefficient data is specified on a pixel-by-pixel basis, the data can be placed in the same locations where pixel data normally would be placed. If more precision is needed for non-image coefficient data than is used in a data frame to specify pixel values, a higher precision coefficient can be divided among successive data frames or among multiple color channel data frames that are transmitted in parallel can be loaded with parts of the coefficient values. Divided coefficient values can be reconstructed by the receiver. Alternatively, higher precision coefficients could use multiple pixel positions in each data frame so that, for instance, only half or a quarter of a coefficient set would be sent in a single data frame. In the blending application, it will be recognized that most of the data frame will specify fully bright pixels (unless blending is combined with color and/or brightness correction.) For border areas, where the data blends images from adjacent projectors, a taper function controls the edge blending. This paper function typically would be curvilinear, rather than linear, because that produces a smoother transition.

Alternatively, a blending map can be expressed by polynomial coefficients or control points on a blending curve. At a graphic interface, a blending curve can be specified using controls similar to the “curves” function in Photoshop®. Or, a bending map can be specified using polynomial coefficients as described by the GEO Semiconductor in its presentation to the AGC Conference, previously incorporated by reference, or any of the data forms suggested by U.S. Pat. No. 7,384,158. A blending map need not be pixel-by-pixel; these alternative forms of blending parameters could be transmitted as a blending map.

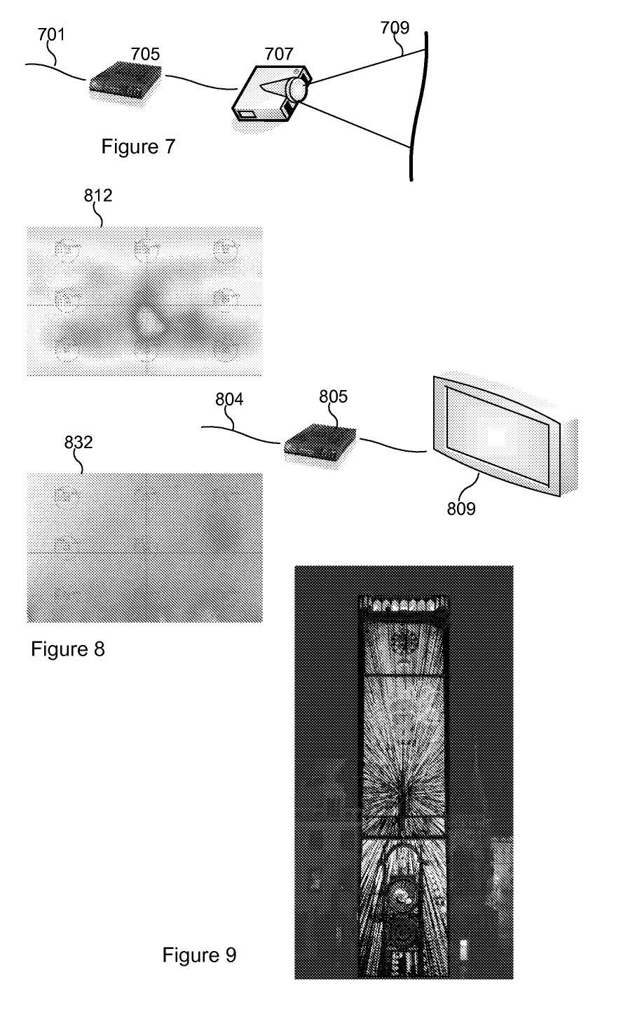

FIG. 7 depicts a warping application of the technology disclosed. Note that warping typically is used when blending edges, to compensate for rotations and off axis projection. Of course, warping also can be used without edge blending. For warping, image and non-image data are delivered via a high-speed digital pixel cable 701 to a warping node 705. The warping node is the receiver 509 of FIG. 5. When a projector 707 displays an image on an irregular surface 709, a pixel displacement map may be transmitted to the warping node 705 to provide detailed warping map of displacement coordinates. In one implementation, each displacement includes two parameters. The displacement parameters may be expressed in either Cartesian or polar coordinates. As described above, alternatives to a pixel-by-pixel warping map include other forms of warping parameters, such as polynomial coefficients or transformed corner positions. A warping map need not be pixel-by-pixel; these alternative forms of warping parameters could be transmitted as a warping map.

There are some instances in which pixel-by-pixel warping data may be particularly valuable, such as painting a building with light. FIG. 9 depicts of an astronomical bell tower in Prague painted with light by Macula to celebrate the tower's 600th anniversary. This recent event went viral, because of extraordinary work that presently can be viewed at TheMacula.com. Pixel-by-pixel displacement information for a warping map would be very useful for adjusting projections onto the irregular surface of an old building such as the clock tower or even onto a new building. Use of three-dimensional, laser-based building mapping, such as performed by the nonprofit CyArk, could be combined with a pixel-by-pixel warping map to greatly simplify a projection project such as the Prague clock tower.

FIG. 8 depicts color/brightness mapping of the display. Maps 812, 832 are brightness and intensity maps for a backlit LCD flat panel produced by GEO Semiconductor. The variation in gray tones in 812, 832 indicates variations for which the color balance node 805 could be used to color compensate. In this application, a color configuration device (not depicted) would send color and/or brightness map data across a high-speed digital pixel cable 804 to the color balance node, which includes a receiver such as 509 in FIG. 5. In some data frames sent over the cable 804, as indicated by a side channel signal, the color balance node would receive a color balance map. This map could include pixel-by-pixel color and/or intensity data or polynomial coefficients as described by the GEO Semiconductor in its presentation to the AGC Conference, previously incorporated by reference, or any of the data forms suggested by U.S. Pat. No. 7,384,158.

From FIGS. 6-8, we can generalize the technology disclosed. In general, there is a source of image data 601. It can, for instance, be a wide or large screen digital recording or it can be multiple workstations that supply data to be positioned on demand in some portion of a display wall. There is an image controller 603, which can be one or more physical devices. Sometimes, it is a server with multiple blades and multiple video output ports. Other times, it is a controller coupled to multiple output modules that have one or more video output ports. High-speed digital pixel cables 604, 704, 804 connect the video output ports to configurable pixel processing nodes 605, 705, 805. The pixel processing nodes process pixel data and pass it onto a video device such as a projector 607, 707 or a flat panel display 807. Projectors may be aimed at a flat display wall 609 that is front or back lit. Alternatively, projectors may be aimed at a non-flat surface 709, which may even be a building such as the astronomical bell tower in Prague, depicted in FIG. 9.

The so-called image controller 603 sends both image and non-image data over the high-speed digital pixel cables 604, 704, 804 to the pixel processing nodes 605, 705, 805. Non-image data is transmitted in data frames over a main pixel channel of the high-speed digital pixel cables. A side channel signal is transmitted to indicate which data frames contain non-image data, as opposed to image data. The pixel processing nodes can perform any combination of edge blending, warping, color correction, and brightness correction. Other graphic operations could be performed by the pixel processing nodes instead of or in addition to these well-understood image manipulations.

The high-speed digital pixel cables may be compliant with DVI, HDMI or DisplayPort standards. The transmitter and receiver are modified from the standards to use a side channel to distinguish among data frames that contain image and non-image data.

Data frames of non-image data may be used for pixel-by-pixel coefficient data. Pixel-by-pixel coefficients may be the same precision as used for pixel image data or higher precision. Higher precision coefficients can be carried in parts by different data frames using the same positions in the data frame as used for image pixels. Or, subsets of higher precision coefficients can be carried in multiple data frames. The multiple data frames can be transmitted sequentially or in parallel, as high-speed pixel data cables are designed to carry data frames for multiple color components in parallel.

Data frames of non-image data alternatively can be used for other forms of coefficient data or even for arbitrary data. Coefficient data can be specified by polynomial coefficients as described by the GEO Semiconductor in its presentation to the AGC Conference, previously incorporated by reference, or any of the data forms suggested by U.S. Pat. No. 7,384,158. Arbitrary data can be transmitted at a high speed in data frames in the main pixel data channel of high-speed digital pixel cables using the technology disclosed. One useful application for arbitrary data is to load a firmware or software update into the pixel processing nodes.

Optionally, the receiver can reuse a frame of image data previously received when it is processing one or more data frames of non-image data, to avoid creating a meaningless image and potentially annoying flash on the screen representing the non-image data. During a firmware update, for instance, this reused or frozen frame could be an informative message.

### Some Particular Embodiments

The technology disclosed can be practiced in a variety of methods or as device adapted to practice the methods. The same methods can be viewed from the perspective of a transmitter, transmission media or receiver. The devices may be a transmitter, receiver or system including a transmitter and receiver. The technology disclosed also may be practiced as an article of manufacture such as non-transitory memory loaded with computer program instructions to carry out any method disclosed or which, when combined with hardware, produce any of the devices as disclosed.

One method helps users configure edge blending between multiple projectors. Configurable blending nodes may be supplied with configuration data via a high-speed digital pixel cable that carries a main pixel channel and a side channel. Alternatively, the method could be practiced with configurable blending components and other paths for carrying a main pixel channel and the side channel, as described above.

This first method includes delivering blending map data via a high-speed digital pixel cable to blending nodes during configuration, using a main pixel channel of the cable to carry data frames of blending map data. The method further includes using a side channel of the cable to indicate the particular data frames sent on the main pixel channel are to be treated as blending map data, instead of pixel data.

Implementing this method, the blending map data may include pixel-by-pixel blending parameter data. Alternatively, it may include polynomial coefficients or control positions on a spline curve. The blending map data may be specified for all positions in a data frame or just for blending regions, in which projected images overlap.

Optionally, when pixel-by-pixel blend parameter data is specified, the parameter data may be positioned in a data frame using the same data positions in the data frame for parameter or non-image data as used for pixel or image data.

Another method helps users configure or execute warping by one or more warping nodes. Warping nodes may be supplied with configuration data via a high-speed digital pixel cable that carries a main pixel channel and a side channel. Alternatively, the method could be practiced with warping components and other paths for carrying a main pixel channel and the side channel, as described above.

This second method includes delivering warping map data via a high-speed digital pixel cable to warping nodes during configuration, using a main pixel channel of the cable to carry data frames of warping map data. The method further includes using a side channel of the cable to indicate the particular data frames sent on the main pixel channel are to be treated as warping map data, instead of pixel data.

Implementing this method, the warping map data may include pixel-by-pixel pixel displacement data. Alternatively, it may include polynomial coefficients or control positions on a spline curve.

Optionally, when pixel-by-pixel warping map data is specified, the pixel displacement data may be positioned in a data frame using the same data positions in the data frame for parameter or non-image data as used for pixel or image data. As two displacement parameters are typically used to express two-dimensional displacement, two data frames may be transmitted either in parallel or sequentially. More data frames can be used for higher precision.

A third method helps users configure color and/or intensity using one or more configurable color balance nodes. Configurable color balance nodes may be supplied with configuration data via a high-speed digital pixel cable that carries a main pixel channel and a side channel. Alternatively, the method could be practiced with configurable color balance components and other paths for carrying a main pixel channel and the side channel, as described above.

This third method includes delivering color balance map data via a high-speed digital pixel cable to color balance nodes during configuration, using a main pixel channel of the cable to carry data frames of warping map data. The method further includes using a side channel of the cable to indicate the particular data frames sent on the main pixel channel are to be treated as color balance map data, instead of pixel data.

Implementing this method, the color balance map data may include pixel-by-pixel pixel color and/or intensity data. Alternatively, it may include polynomial coefficients or control positions on a spline curve.

Optionally, when pixel-by-pixel color balance map data is specified, the color and/or intensity data may be positioned in a data frame using the same data positions in the data frame for parameter or non-image data as used for pixel or image data. For color balance data, separate data frames may be transmitted either in parallel or sequentially for separate color and/or intensity channels. More data frames can be used for higher precision.

For any of the blending map, warping map or color balance map methods for the general method described below, when a high-speed digital pixel cable is used, the cable may be a DVI-compliant cable, an HDMI-compliant cable or DisplayPort-compliant cable. With any of these standard compliant cables or other possible cable designs, the side channel may be implemented as a Display Data Channel (DDC) of the cable. With some cable designs, the side channel may be the channel that implements Consumer Electronics Commands (CEC).

For any of these methods or for the general method described below, with the standard compliant cables or other possible cable designs, a spare sub channel could alternatively be used or an unused sub channel co-opted to distinguish between frames used for image and non-image data. Either a binary signal or command could be used.

In some implementations of these methods, standard-compliant signals are converted to an optical data stream for transmission.

A general method delivers non-image data frames to one or more pixel processing nodes that receive data via a high-speed digital pixel cable that include a main pixel channel and a side channel. Alternatively, this general method could be practiced with pixel processing components and other paths for carrying a main pixel channel and the side channel, as described above.

This general method includes delivering non-image data via a high-speed digital pixel cable to pixel processing nodes using a main pixel channel of the cable to carry data frames of non-image map data. The method further includes using a side channel of the cable to indicate the particular data frames sent on the main pixel channel are to be treated as non-image data, instead of image data.

Implementing this method, the non-image may include pixel-by-pixel data. Alternatively, it may include polynomial coefficients or control positions on a spline curve. It may include arbitrary data, such as a firmware or software update.

Optionally, when pixel-by-pixel non-image is specified, the color and/or intensity data may be positioned in a data frame using the same data positions in the data frame for parameter or non-image data as used for pixel or image data. Separate but related data frames may be transmitted either in parallel or sequentially for separate color and/or intensity channels. More data frames can be used for higher precision.

As with the blending map method, when a high-speed digital pixel cable is used, the cable may be a DVI-compliant cable, an HDMI-compliant cable or DisplayPort-compliant cable. With any of these standard compliant cables or other possible cable designs, the side channel may be implemented as a Display Data Channel (DDC) of the cable. With some cable designs, the side channel may be the channel that implements Consumer Electronics Commands (CEC).

Again, with the standard compliant cables or other possible cable designs, a spare sub channel could alternatively be used or an unused sub channel co-opted to distinguish between frames used for image and non-image data. Either a binary signal or command could be used.

In some implementations, standard-compliant signals are converted to an optical data stream for transmission.

Corresponding to each of these methods are transmitters, receivers and systems that include both transmitters and receivers.

One device is a transmitter that sends non-image data frames to one or more pixel processing nodes via a high-speed digital pixel cable. This transmitter includes a port to transmit frames of data on a main channel and to transmit control data on a side channel, when coupled to a high-speed digital pixel cable that carries both channels. The transmitter includes at least one data frame buffer coupled to the port and to the main channel. It further includes a buffer context signal generator coupled to the port and to the side channel. The buffer context signal generator at least signals whether a particular data set in the data frame buffer contains a frame of image data or of non-image data.

Complementary to the transmitter is a receiver that receives non-image data frames at a pixel processing node via a high-speed digital pixel cable. This receiver includes a port to receive frames of data on a main channel and control data on a side channel, when coupled to a high-speed digital pixel cable that carries both channels. The receiver includes at least one data frame buffer coupled to the port and to the main channel. It further includes a buffer context detector coupled to the port and to the side channel. The buffer context detector receives signals over the side channel and determines whether a particular data set received in the data frame buffer contains a frame of image data or of non-image data.

The transmitter, receiver and high-speed digital pixel cable may be combined in a system.

In alternative device embodiments, a high-speed digital pixel path may be substituted for the cable and a pixel processing component substituted for the pixel processing node. These options are described above.

When a high-speed digital pixel cable is used, the cable may be a DVI-compliant cable, an HDMI-compliant cable or DisplayPort-compliant cable. With any of these standard compliant cables or other possible cable designs, the side channel may be implemented as a Display Data Channel (DDC) of the cable. With some cable designs, the side channel may be the channel that implements Consumer Electronics Commands (CEC).

With the standard compliant cables or other possible cable designs, a spare sub channel could alternatively be used or an unused sub channel co-opted to distinguish between frames used for image and non-image data. Either a binary signal or command could be used.

In some implementations, standard-compliant signals are converted to an optical data stream for transmission.

One particular application of the transmitter, receiver or system device is delivering blending map data to blending nodes during configuration. In this application, the pixel processing nodes are blending nodes used to blend images projected by multiple, overlapping image projectors. The non-image data is blending map data. This blending map data may include pixel-by-pixel blending parameter data. Alternatively, it may include polynomial coefficients or control positions on spline curve. The blending map may be specified for all positions in the data frame were just for blending regions, in which the projected images overlap.

Another application of the transmitter, receiver or system device is delivering one or more warping map data to warping nodes. In this application, the pixel processing nodes are warping nodes used to warp images projected by an image projector or displayed on a screen. The non-image data is warping map data. This blending map data may include pixel-by-pixel blending parameter data. The warping map may be specified as pixel displacements. Alternatively, it may include polynomial coefficients or control positions of a grid.

Yet another application of the transmitter, receiver or system device is delivering one or more color and/or intensity adjustment maps to warping nodes during configuration. In this application, the pixel processing nodes are color balance nodes used to color balance images projected by an image projector or displayed on a screen. The non-image data is color and/or intensity adjustment map data. The color adjustment map for each color channel being used. This color adjustment map data may include pixel-by-pixel color adjustment parameter data. Alternatively, it may include polynomial coefficients or control positions of a grid.

Optionally, when pixel-by-pixel blending, warping or color balance parameter data as specified, the parameter data may be positioned as a data frame using the same data positions the data frame for parameter or non-image data is used for pixel or image data.

As mentioned above, the technology disclosed also may be practiced as an article of manufacture, as a non-transitory memory containing computer instructions. In one implementation, the computer instructions in the non-transitory memory, when combined with hardware, cause the combined system to carry out any of the methods disclosed. In another implementation, the computer instructions in the non-transitory memory, when combined with hardware, form a transmitter, receiver or system as disclosed. The non-transitory memory may be rotating or non-rotating. It may be magnetic, optical or any other type of non-transitory memory.

The technology disclosed also may be practiced as software that includes instructions to carry out any of the methods disclosed. Or, as software that includes instructions that can be combined with hardware to produce any of the transmitters, receivers or systems disclosed.

We claim as follows:

1. A method of delivery of non-image data frames to one or more pixel processing nodes that receive data via a high-speed digital pixel cable, the method including:
delivering non-image data via the high-speed digital pixel cable to the pixel processing nodes using a main pixel channel of the cable to carry data frames of the non-image data; and
using a side channel of the cable to indicate that particular data frames sent on the main pixel channel are to be treated as non-image data instead of pixel data.

2. The method of claim 1, wherein the non-image data includes pixel-by-pixel data positioned in a data frame using a same correspondence of data position in the data frame as used for pixel data.

3. The method of claim 1, wherein the pixel processing nodes are blending nodes, wherein:
the non-image data includes data frames of blend map data; and
the side channel is used to indicate that the particular data frames sent on the main pixel channel are to be treated as blend map data instead of pixel data.

4. The method of claim 3, wherein the blend map data includes pixel-by-pixel blend parameter data.

5. The method of claim 4, wherein the pixel-by-pixel blend parameter data is positioned in a data frame using a same correspondence of data position in the data frame as used for pixel data.

6. The method of claim 1, wherein the high-speed digital pixel cable is a DVI-compliant cable.

7. The method of claim 1, wherein the high-speed digital pixel cable is an HDMI-compliant cable.

8. The method of claim 1, wherein the high-speed digital pixel cable is a DisplayPort-compliant cable.

9. The method of claim 6, wherein the side channel is a Display Data Channel of the DVI-compliant cable.

10. The method of claim 1, wherein the side channel is implemented by a signal on a spare conductor of the high-speed digital pixel cable.

11. The method of claim 1, wherein the high-speed digital pixel cable is optical.

12. The method of claim 1, wherein the pixel processing nodes are configurable color compensation nodes, the method including:
the non-image data includes data frames of the color compensation map data; and
the side channel is used to indicate that the particular data frames sent on the main pixel channel are to be treated as color compensation map data instead of pixel data.

13. The method of claim 12, wherein the color compensation map data includes pixel-by-pixel blend parameter data.

14. The method of claim 13, wherein the pixel-by-pixel color compensation parameter data is positioned in a data frame using a same correspondence of data position in the data frame as used for pixel data.

15. The method of claim 1, wherein the pixel processing nodes are warping nodes, the method including:
the non-image data includes data frames of the warping map data; and
the side channel is used to indicate that the particular data frames sent on the main pixel channel are to be treated as warping map data instead of pixel data.

16. The method of claim 15, wherein the warping map data includes pixel-by-pixel blend parameter data.

17. The method of claim 16, wherein the pixel-by-pixel warping parameter data is positioned in a data frame using a same correspondence of data position in the data frame as used for pixel data.

18. An apparatus that sends non-image data frames to one or more pixel processing nodes that receive data via a high-speed digital pixel cable, the apparatus including:
a port that transmits frames of data on a main channel and control data on a side channel, when coupled to a high-speed digital pixel cable;
at least one data frame buffer coupled to the port and the main channel;
a buffer context signal generator coupled to the port and the side channel that indicates whether a particular data set in the date frame buffer contains a frame of image data or contains non-image data.

19. The apparatus of claim 18, wherein the port transmits data frames of blend map data via the main pixel channel and the buffer context signal generator transmits a signal using the side channel that indicates whether particular data frames sent on the main pixel channel are to be treated as blend map data instead of pixel data.

20. The apparatus of claim 18, wherein the port transmits data frames of color compensation map data via the main pixel channel of the cable and the buffer context signal generator transmits a signal using the side channel that indicates whether particular data frames sent on the main pixel channel are to be treated as color compensation map data instead of pixel data.

21. The apparatus of claim 18, wherein the port transmits data frames of warping map data via the main pixel channel of the cable to carry blend map data and the buffer context signal generator transmits a signal using the side channel that indicates whether particular data frames sent on the main pixel channel are to be treated as warping map data instead of pixel data.
